(19) United States
(12) Patent Application Publication
(10) Pub. No.: US 2026/0251805 A1
(43) Pub. Date: Aug. 27, 2026

(54) POSITIONING APPARATUS AND METHOD BASED ON SPACE DIVISION

(71) Applicant: ELECTRONICS AND TELECOMMUNICATIONS RESEARCH INSTITUTE, Daejeon (KR)

(72) Inventor: JaeJun Yoo, Daejeon (KR)

(21) Appl. No.: 19/361,614

(22) Filed: Oct. 17, 2025

(30) Foreign Application Priority Data
Feb. 21, 2025 (KR) 10-2025-0022848

(51) Int. Cl. G01S 19/42; H04L 41/02

(52) U.S. Cl. CPC G01S 19/42; H04L 41/024

(57) ABSTRACT

The present invention relates to a positioning apparatus and method based on space division. The method includes establishing a positioning DB based on first positioning data collected at a shaded area, obtaining positioning accuracy through a simulation based on the positioning DB, dividing a space of the shaded area into a plurality of spaces based on the positioning accuracy, resetting a similarity function applied to each divided space, collecting second positioning data from a user terminal, calculating a similarity value between the first positioning data stored in the positioning DB and the second positioning data with respect to each location of the shaded area by using the reset similarity function, and determining a location corresponding to a maximum value of the calculated similarity values among the respective locations as a location of the user terminal.

### CROSS-REFERENCE TO RELATED APPLICATION

This application claims priority to and the benefit of Korean Patent Application No. 10-2025-0022848, filed on February 21, 2025, the disclosure of which is incorporated herein by reference in its entirety.

### BACKGROUND

### 1. Field of the Invention

The present invention relates to an apparatus and method for determining a location of a target object using a wireless signal or a sensing signal in an area where the reception status of a satellite signal is weak (a shaded area).

### 2. Discussion of Related Art

Various mobile devices including smartphones are being widely used, and indoor spaces such as shopping malls are becoming larger. As a result, the demand for methods and devices for positioning mobile terminals in indoor spaces is increasing. For example, customers in shopping malls need to know their current locations in order to find elevators, escalators, restrooms, and the like.

Unlike outdoor areas where global navigation satellite system (GNSS) signals that enable satellite-based positioning are well received, separate signals are needed in indoor areas where GNSS signals are shadowed. For example, various methods that utilize wireless signals such as Wi-Fi, Long Term Evolution (LTE), and Bluetooth Low Energy (BLE), as well as geomagnetic sensors and images, are being attempted.

A representative method among positioning methods using wireless signals and sensors is a fingerprint technique. The fingerprint technique is a method of pre-establishing a positioning DB (positioning infrastructure database) for a target space based on positioning information such as wireless signals such as Wi-Fi, BLE, and LTE, and geomagnetic and image information collected at each location of the target space, and then comparing real-time positioning information scanned by a mobile terminal in the target space with positioning information in the pre-established positioning DB to determine the location with the most similar positioning information as the location of the mobile terminal. In this fingerprint-based indoor positioning, the accuracy of positioning can be determined by a similarity search method for the positioning DB.

The similarity function that needs to be defined to perform fingerprint-based indoor positioning in a GNSS shaded area can be defined in various forms. Here, the cosine similarity function is generally used, and a similarity function designed separately for indoor positioning can be defined and used.

The positioning data (e.g., a Wi-Fi list or a received signal strength indicator (RSSI)) collected at each location in the GNSS shaded area varies depending on the type, shape, and characteristics of the GNSS shaded area. For example, the positioning data collected at each location in a narrow corridor-shaped GNSS shaded area and a wide square or hall-shaped GNSS shaded area show different types of signal characteristics and patterns. In other words, these signal characteristics and patterns depend on the characteristics of the space.

Therefore, when providing fingerprint-based positioning in a GNSS shaded area, in order to increase the overall positioning accuracy throughout the target space and maintain the accuracy at an appropriate level, it is necessary to separately define and utilize a similarity function that reflects the propagation characteristics of the space well.

### SUMMARY OF THE INVENTION

The present invention is directed to providing a space-division-based positioning apparatus and method, which divides a target space according to predetermined criteria and applies a different similarity function to each divided space for accurate and stable positioning when applying fingerprint-based positioning in a global navigation satellite system (GNSS) shaded area.

The problems of the present invention are not limited to the problems mentioned above, and other problems that are not mentioned will be clearly understood by those skilled in the art from the description below.

According to an aspect of the present invention, there is provided a positioning method which includes: collecting, by a positioning data collector, first positioning data and transmitting the collected first positioning data to a positioning apparatus in order to establish a positioning DB, wherein the first positioning data includes a list of positioning resources, which transmit wireless signals to the positioning data collector from among a plurality of positioning resources arranged in a target GNSS shaded area at a plurality of locations set in the target GNSS shaded area, and signal strengths of wireless signals transmitted by each positioning resource included in the list of positioning resources; storing, by the positioning apparatus, the first positioning data in a storage unit to establish the positioning DB; generating, by the positioning apparatus, simulated positioning data by performing a simulation based on the positioning DB, obtaining a similarity between the simulated positioning data and the first positioning data extracted from the positioning DB by applying a preset similarity function, and obtaining a positioning accuracy for each of the plurality of locations based on the similarity between the simulated positioning data and the first positioning data extracted from the positioning DB; dividing, by the positioning apparatus, a space of the target GNSS shaded area into a plurality of spaces based on the positioning accuracy, and generating divided space information of the target GNSS shaded area based on a result of the dividing; optimizing, by the positioning apparatus, parameters of the similarity function so that the positioning accuracy obtained based on the positioning DB is maximized for the divided space having the positioning accuracy lower than a predetermined threshold value among the divided spaces included in the target GNSS shaded area, and resetting the similarity function of the positioning accuracy lower than the threshold value; generating, by the positioning apparatus, a mapping table representing a relationship between the divided space information of the target GNSS shaded area and the similarity function applied to each divided space based on a result of the resetting of the similarity function; collecting in real time, by a user terminal that has entered the target GNSS shaded area to determine its own location, the list of positioning resources transmitting wireless signals around the user terminal and a signal strength of the wireless signal transmitted from each positioning resource to the user terminal to generate second positioning data, and transmitting the second positioning data to the positioning apparatus; determining, by the positioning apparatus, the divided space including each location of the target GNSS shaded area based on the mapping table, extracting a similarity function corresponding to each divided space of the target GNSS shaded area from the mapping table, and calculating a similarity value between the first positioning data stored in the positioning DB and the second positioning data with respect to each location using the extracted similarity function; and determining, by the positioning apparatus, among each of the locations, a location corresponding to a maximum value among the calculated similarity values as a location of the user terminal.

The positioning method may further include, transmitting, by the positioning apparatus, the location corresponding to the maximum value to the user terminal.

According to another aspect of the present invention, there is provided a positioning apparatus which includes: a communication unit configured to receive, from a positioning data collector, first positioning data including a list of positioning resources, which transmit wireless signals to the positioning data collector from among a plurality of positioning resources disposed in a target GNSS shaded area, and signal strengths of wireless signals transmitted by each positioning resource included in the list of positioning resources; a storage unit; a memory configured to store computer-readable instructions; and at least one processor implemented to execute the instructions.

The at least one processor may execute the instructions to: store the first positioning data in the storage unit to establish a positioning DB; generate simulated positioning data by performing a simulation based on the positioning DB, obtain a similarity between the simulated positioning data and the first positioning data extracted from the positioning DB by applying a preset similarity function, and obtain a positioning accuracy for each of the plurality of locations based on the similarity between the simulated positioning data and the first positioning data extracted from the positioning DB; divide a space of the target GNSS shaded area into a plurality of spaces based on the positioning accuracy, and generate divided space information of the target GNSS shaded area based on a result of the dividing; optimize parameters of the similarity function so that the positioning accuracy obtained based on the positioning DB is maximized for the divided space having the positioning accuracy lower than a predetermined threshold value among the divided spaces included in the target GNSS shaded area to reset the similarity function of the positioning accuracy lower than the threshold value; and generate a mapping table representing a relationship between the divided space information of the target GNSS shaded area and the similarity function applied to each divided space based on a result of the resetting of the similarity function; and wherein the communication unit is configured to: determine, when receiving second positioning data which is real-time positioning data including the list of positioning resources transmitting wireless signals around the user terminal from a user terminal that has entered the target GNSS shaded area and a signal strength of the wireless signal transmitted from each positioning resource to the user terminal, the divided space including each location of the target GNSS shaded area based on the mapping table, extract a similarity function corresponding to each divided space of the target GNSS shaded area from the mapping table, and calculate a similarity value between the first positioning data stored in the positioning DB and the second positioning data with respect to each location using the extracted similarity function; and determine, among each of the locations, a location corresponding to a maximum value among the calculated similarity values as a location of the user terminal.

The at least one processor may be configured to transmit the location corresponding to the maximum value to the user terminal through the communication unit.

The above-described configurations and operations of the present invention will become more apparent from embodiments described in detail below with reference to the drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIGS. 1 and 2 are diagrams illustrating a method of performing positioning based on a fingerprint for Wi-Fi in a global navigation satellite system (GNSS) shaded area;

FIG. 3 is a block diagram illustrating a configuration of a positioning apparatus according to an embodiment of the present invention;

FIG. 4 is an exemplary diagram illustrating a positioning data collecting location in a GNSS shaded area;

FIGS. 5A to 5D are diagrams illustrating a case of space division in a GNSS shaded area;

FIG. 6 is an exemplary diagram illustrating a mapping table between a divided space and a similarity function;

FIG. 7 is a flowchart illustrating a method of dividing a space and configuring a similarity function according to an embodiment of the present invention; and

FIG. 8 is a flowchart illustrating a positioning method according to an embodiment of the present invention.

### DETAILED DESCRIPTION OF EXEMPLARY EMBODIMENTS

The present invention relates to an apparatus and method for determining the location of a target object using a wireless signal or a sensing signal in an area where the reception status of a satellite signal is weak (a shaded area). The present invention can be applied to a system for determining the exact location of a mobile terminal in a global navigation satellite system (GNSS) shaded area such as an indoor area. That is, the present invention can support indoor positioning. The GNSS shaded area, which is the positioning target of the present invention, can be an indoor space.

Specifically, the present invention can divide a target indoor space and provide indoor positioning optimized for the situation of each divided space.

Advantages and features of the present invention and methods for achieving them will be made clear from embodiments described in detail below with reference to the accompanying drawings. However, the present invention may be embodied in many different forms and should not be construed as being limited to the embodiments set forth herein. Rather, these embodiments are provided so that this disclosure will be thorough and complete and will fully convey the scope of the present invention to those of ordinary skill in the technical field to which the present invention pertains. The present invention is defined by the claims. Meanwhile, terms used herein are for the purpose of describing the embodiments and are not intended to limit the present invention. As used herein, the singular forms include the plural forms as well unless the context clearly indicates otherwise. The term “comprise” or “comprising” used herein does not preclude the presence or addition of one or more elements, steps, operations, and/or devices other than stated elements, steps, operations, and/or devices.

Terms such as “first,” “second,” and the like may be used to describe various components, but the components are not to be construed as being limited to the terms. The terms are used only to distinguish one component from another component. For example, a “first” component may be called a “second” component and a “second” component may also be similarly called a “first” component without departing from the scope of the present invention.

It is to be understood that when a first element is referred to as being “connected to” or “coupled to” a second element, it may be connected or coupled directly to the second element or connected to or coupled to the second element with a third element intervening therebetween. On the other hand, it is to be understood that when a first element is referred to as being “connected directly to” or “coupled directly to” a second element, it is connected or coupled to the second element with no other element intervening therebetween. Other expressions describing relationships between components, such as “between,” “directly between,” “neighboring,” “directly neighboring,” and the like, should be similarly interpreted.

Further, in describing the present invention, the detailed description of a related known configuration or function will be omitted when it obscures the gist of the present invention.

Hereinafter, embodiments of the present invention will be described in detail with reference to the attached drawings. In order to facilitate overall understanding in describing the present invention, the same reference numbers will be used for the same means throughout the drawings.

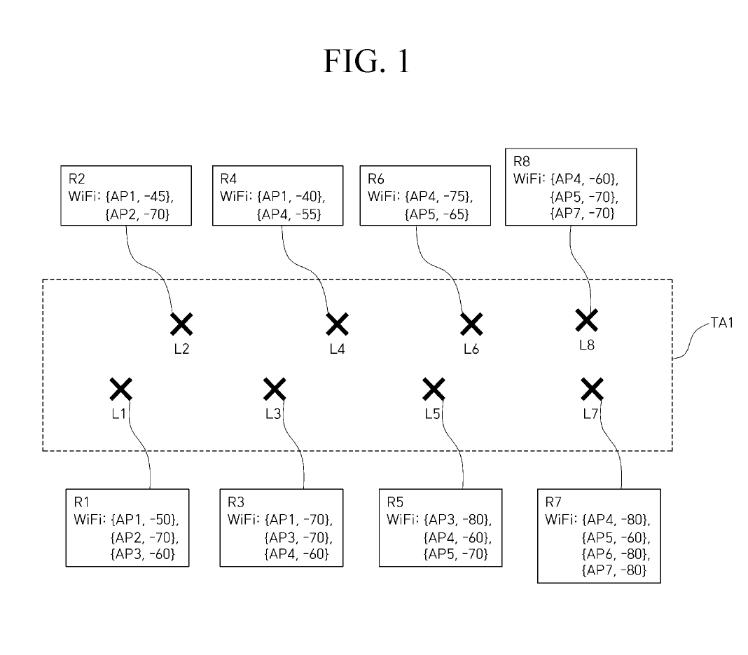

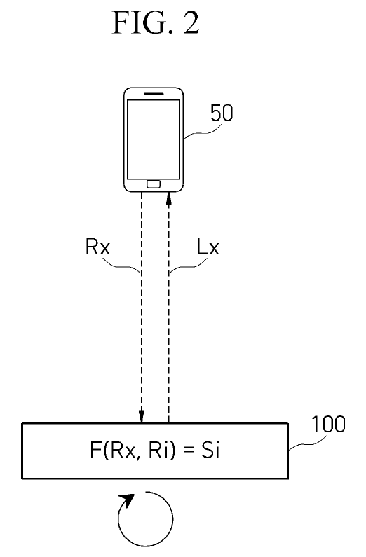

FIGS. 1 and 2 are diagrams illustrating a method of performing positioning based on a fingerprint for Wi-Fi in a GNSS shaded area. For convenience of description, it is assumed that a user terminal 50 performs positioning by transmitting and receiving data to and from a positioning apparatus 100.

FIG. 1 illustrates access points AP1 to AP7 capable of identification and signal reception, and received signal strength indicator (RSSI, hereinafter referred to as “received signal strength” or “signal strength”) values for each access point, for each location L1 to L8 of a GNSS shaded area TA1. In this specification, a list of access points (APs) (which may be referred to as a “Wi-Fi list”) collected at each location L1 to L8 of a target GNSS shaded area and a strength of a signal received from each access point (“received signal strength” or “signal strength”) are referred to as “positioning data”. A positioning data collector 40 measures the strength of a wireless signal received from each access point to generate positioning data while identifying access points transmitting Wi-Fi signals at locations L1 to L8 of the GNSS shaded area TA1 to generate an access point list and transmits the generated positioning data to the positioning apparatus 100.

In FIG. 1, positioning data is represented as R1 to R8. The positioning data may be stored in the positioning DB of the positioning apparatus 100 or the user terminal 50. In the embodiment of FIG. 2, it is assumed that the positioning DB is stored in a storage unit 140 of the positioning apparatus 100.

FIG. 2 is a diagram illustrating a process in which the user terminal 50 performs positioning based on a positioning DB established using positioning data collected at each location of the target GNSS shaded area illustrated in FIG. 1. For example, at the location L1 of FIG. 1, access points AP1, AP2, and AP3 are identified with the signal strengths (RSSIs: received signal strength indicators) of −50, −70, and −60, respectively. It is assumed that a positioning DB storing positioning data, which is RSSI data of each access point AP1 to AP7 with respect to each location L1 to L8 of the GNSS shaded area TA1, has been established in advance. That is, the positioning DB stores a list of access points collected in advance and positioning data Ri including the RSSI of each access point, for each location Li of the target GNSS shaded area TA1.

The process of determining the location of the user terminal 50 using the positioning DB is as follows.

1) The user terminal 50 that desires to determine its own location at a positioning target point of the corresponding GNSS shaded area TA1 acquires positioning data such as a list of Wi-Fi access points APs and the RSSI of each access point in real time. That is, the positioning data may refer to Wi-Fi signal information collected to determine the location of the user terminal 50. For example, in FIG. 1, the user terminal 50 acquires RSSI1, RSSI2, and RSSI3, which are the signal strengths of the access points AP3, AP4, and AP5. In FIG. 2, the positioning data including the list of access points and the RSSI of each access point is represented as Rx. The user terminal 50 transmits the positioning data Rx, collected in real time, to the positioning apparatus 100.

2) The positioning apparatus 100 acquires the positioning data Rx, collected in real time by the user terminal 50, from the user terminal 50. The positioning apparatus 100 may be an apparatus mounted on the user terminal 50 or may be an apparatus located outside the user terminal 50. The positioning apparatus 100 determines the location of the user terminal 50 using a similarity function F based on the positioning data Rx collected in real time and the positioning data Ri stored in the positioning DB.

Specifically, the positioning apparatus 100 calculates a similarity Si (i=1, 2, …, and 8) by executing a similarity function F and comparing the positioning data Ri collected in advance at each point Li (i=1, 2, …, and 8) of the corresponding GNSS shaded area TA1, that is, the list of Wi-Fi access points AP1 to AP7 and the signal strength of each access point stored in the positioning DB, with the positioning data Rx including the list of access points collected in real time by the user terminal 50 and the signal strength of each access point.

3) The positioning apparatus 100 transmits a location Lx corresponding to a maximum value Sx among the calculated similarities to the user terminal 50.

A process in which the positioning apparatus 100 determines the location of a user terminal using a fingerprinting technique in a GNSS shaded area according to an embodiment of the present invention has been described above with reference to FIGS. 1 and 2. The positioning process using the Wi-Fi signals has been described in the above example, but a positioning method using the fingerprint technique can be implemented not only for Wi-Fi but also for various types of positioning resources such as BLE, LTE, and geomagnetic sensors.

The positioning accuracy obtained through the fingerprinting technique varies depending on the execution result of the similarity function F that calculates the similarity between the search result of the positioning DB established in the GNSS shaded area in advance and the similarity of real-time positioning data.

The similarity function F can be defined in many different forms. A commonly used similarity function F is the cosine similarity function, but a defined separately similarity function can be used.

The positioning data (e.g., the list of Wi-Fi access points and signal strength (RSSI)) collected at each internal location in the GNSS shaded area show different characteristics and patterns depending on the characteristics of the GNSS shaded area determined by the type and shape of the GNSS shaded area. Examples of the types of GNSS shaded areas include high-rise buildings in urban areas, forests, tunnels, underground spaces, indoor spaces, and mountainous areas. Examples of the GNSS shaded areas include linear spaces (e.g., long narrow corridors or passageways), wide open spaces (e.g., plazas, shopping malls, and underground parking lots), and irregular shapes (e.g., valleys). The characteristics of the GNSS shaded areas determined by the types and shapes of the GNSS shaded areas include signal blocking, attenuation, reflection, and multipath formation.

For example, positioning data collected at internal locations within a narrow corridor-shaped (linear) GNSS shaded area and within a wide plaza or hall-shaped GNSS shaded area may exhibit different types of signal characteristics and patterns. Such signal characteristics and patterns are dependent on the characteristics of each space.

Due to the signal characteristics and patterns of such positioning data, when attempting to provide fingerprint-based indoor positioning in GNSS shaded areas, it is necessary to separately define and utilize a similarity function that accurately reflects the radio propagation characteristics of the corresponding space in order to improve positioning accuracy across the entire target area and to maintain the accuracy at an appropriate level.

The present invention proposes a positioning method and apparatus that, in fingerprint-based positioning in GNSS shaded areas, provide more accurate and reliable positioning by dividing the target GNSS shaded area according to the characteristics of the internal space of the target GNSS shaded area and applying different similarity functions to the divided spaces.

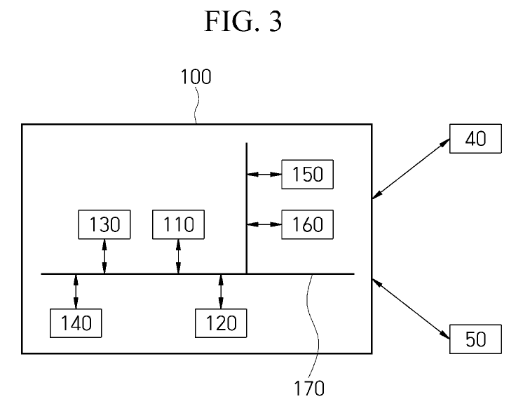

FIG. 3 is a block diagram illustrating a configuration of a positioning apparatus according to an embodiment of the present invention.

Referring to FIG. 3, a positioning apparatus 100 according to the embodiment of the present invention is formed to include a processor 110, a memory 130, a storage unit 140, an input interface unit 150, an output interface unit 160, and a bus 170. The positioning apparatus 100 illustrated in FIG. 3 is merely one embodiment, and the components of the positioning apparatus 100 according to the present invention are not limited to the embodiment illustrated in FIG. 3, and some components may be added, modified, or deleted as needed. For example, the positioning apparatus 100 may further include a communication unit 120 coupled to a network and may not include the input interface unit 150 and/or the output interface unit 160.

The positioning data collector 40 and the user terminal 50 are devices that can transmit and receive data to and from the positioning apparatus 100. The positioning data collector 40 and the user terminal 50 are both formed to include a communication unit, a memory, and a processor.

The positioning apparatus 100 may be mounted on the user terminal 50 that is a location determination target or may be the user terminal 50 itself. In addition, the positioning apparatus 100 may communicate with the user terminal 50 from outside the user terminal 50 to determine the location of the user terminal 50.

The processor 110 may be a central processing unit (CPU) or a semiconductor device that executes computer-readable instructions stored in the memory 130 or the storage unit 140. The memory 130 and the storage unit 140 may include various forms of volatile or nonvolatile storage media. For example, the memory 130 may include a read only memory (ROM) and a random access memory (RAM). In the embodiment of the present disclosure, the memory 130 may be located inside or outside the processor 110, and the memory 130 may be connected to the processor 110 through various means that are already known. The memory 130 may be various forms of volatile or nonvolatile storage media, and for example, the memory 130 may include a ROM or a RAM.

Accordingly, the embodiments of the present invention may be implemented as a computer-implemented method or as a non-transitory computer-readable medium having computer-executable instructions stored thereon. In an embodiment, when the computer-readable instructions are executed by the processor 110, a positioning method according to at least one aspect of the present disclosure may be performed.

The communication unit 120 may transmit or receive wired signals or wireless signals. For example, the communication unit 120 may transmit and receive data to and from the user terminal 50 or receive positioning data from the positioning data collector 40 that has collected positioning data of the target GNSS shaded area in order to establish a positioning DB for the target GNSS shaded area. The processor 110 may establish a positioning DB in the memory 130 or the storage unit 140 based on the positioning data which is collected by the communication unit 120 from the positioning data collector 40.

In addition, the positioning method according to the embodiment of the present invention can be implemented in the form of program instructions that can be executed through various computer means and can be recorded on a computer-readable medium.

The computer readable medium may include, alone or in combination, program instructions, data files and data structures. The program instructions recorded on the computer readable medium may be specially designed and configured for the present disclosure or may be usable by a person skilled in the field of computer software. Computer readable record media include magnetic media such as a hard disk, a floppy disk, or a magnetic tape, optical media such as a compact disc read only memory (CD-ROM) or a digital video disc (DVD), magneto-optical media such as floptical disks, and hardware devices such as a ROM, a RAM, or a flash memory specially designed to store and execute programs. Examples of the program instructions include not only machine language code made by a compiler but also high level code that can be used by an interpreter or the like which is executed by a computer.

Hereinafter, a process in which the positioning apparatus 100 establishes a positioning DB based on positioning data collected at each location of a target GNSS shaded area, divides the space of the target GNSS shaded area using a predetermined space division method, sets a similarity function for each divided space, and determines a location of a user terminal using a relationship between the divided space and the similarity function based on the positioning DB will be described.

In order to establish a positioning DB, the positioning data collector 40 collects first positioning data including a list of positioning resources, which transmit wireless signals to the positioning data collector from among a plurality of positioning resources arranged in a target GNSS shaded area at a plurality of locations set in the target GNSS shaded area, and signal strengths of wireless signals transmitted by each positioning resource included in the list of positioning resources in order to establish a positioning DB. Here, the plurality of positioning resources disposed in the target GNSS shaded area may include any one or a combination of a Wi-Fi access point, a Bluetooth low energy (BLE) beacon, a Long Term Evolution (LTE) base station, and a geomagnetic sensor.

The communication unit 120 receives, from the positioning data collector 40, first positioning data including a list of positioning resources, which transmit wireless signals to the positioning data collector 40 from among a plurality of positioning resources disposed in a target GNSS shaded area, and signal strengths of wireless signals transmitted by each positioning resource included in the list of positioning resources.

The processor 110 stores the first positioning data in the storage unit 140 to establish a positioning DB by executing computer-readable instructions stored in the memory 130 or the storage unit 140.

In addition, the processor 110 generates simulated positioning data by performing a simulation based on the established positioning DB, obtains a similarity between the simulated positioning data and the first positioning data extracted from the positioning DB by applying a predetermined similarity function (e.g., a cosine similarity function), and obtains the positioning accuracy for each of the plurality of locations based on the similarity between the simulated positioning data and the first positioning data extracted from the positioning DB. For example, the processor 110 generates a probability distribution of positioning data of each location Li included in the target GNSS shaded area based on the positioning DB, extracts the simulated positioning data from the probability distribution, calculates a similarity between the simulated positioning data and the first positioning data stored in the positioning DB using a predetermined similarity function, estimates the location of a target object virtually disposed at each location Li based on a maximum value of the similarity, and obtains the positioning accuracy for each of the plurality of locations based on the estimated location.

In addition, the processor 110 divides the space of the target GNSS shaded area into a plurality of spaces based on the obtained positioning accuracy and generates divided space information on the target GNSS shaded area based on the division result. The divided space information may include an identifier of the divided space and a coordinate range included in the divided space or geometric information (e.g., a polygon) indicating the divided space. In the process of dividing the space of the target GNSS shaded area into the plurality of spaces, the processor 110 may utilize not only the obtained positioning accuracy, but also the structural information of the target GNSS shaded area or arrangement information of the plurality of positioning resources installed in the target GNSS shaded area.

The processor 110 optimizes parameters of the predetermined similarity function (meaning that the parameter values of the similarity function are optimally adjusted) so that the positioning accuracy calculated based on the positioning DB is maximized for the divided space with the positioning accuracy lower than a predetermined threshold value among the divided spaces included in the target GNSS shaded area, and resets the similarity function of the positioning accuracy lower than the threshold value.

In addition, the processor 110 generates a mapping table indicating a correspondence relationship between the divided space information of the target GNSS shaded area and the similarity function applied to each divided space based on a result of the resetting of the similarity function.

Next, the communication unit 120 may receive, from the user terminal 50 that has entered the target GNSS shaded area, second positioning data, which is real-time positioning data including a list of positioning resources transmitting wireless signals around the user terminal 50 and the signal strengths of the wireless signals transmitted from each positioning resource to the user terminal.

When the communication unit 120 receives the second positioning data from the user terminal 50, the processor 110 determines the divided space including each location of the target GNSS shaded area based on the mapping table, extracts a similarity function corresponding to each divided space of the target GNSS shaded area from the mapping table, and calculates a similarity value between the first positioning data stored in the positioning DB and the second positioning data for each location using the extracted similarity function.

Next, the processor 110 determines, among the respective locations, the location corresponding to the maximum value among the calculated similarity values as the location of the user terminal 50, and transmits the location corresponding to the maximum value to the user terminal 50 through the communication unit 120.

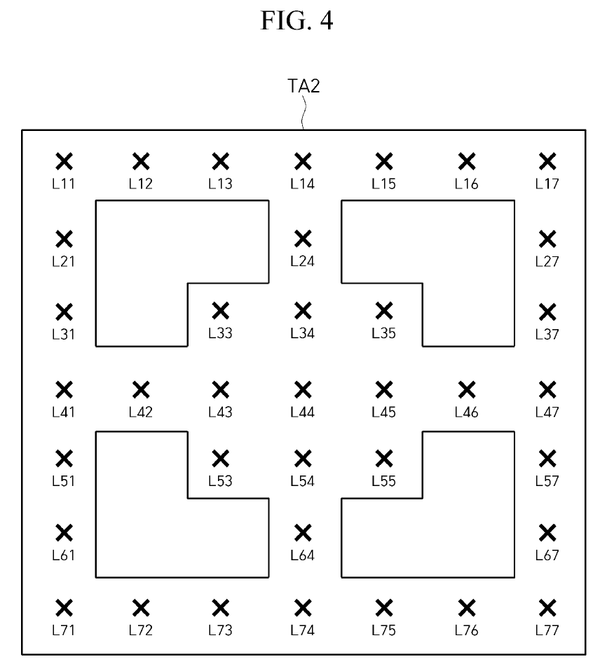

FIG. 4 is an exemplary diagram illustrating a positioning data collecting location in a GNSS shaded area.

In order to perform positioning using the fingerprint technique, it is necessary to establish a positioning DB for a target GNSS shaded area TA2. FIG. 4 illustrates an example of configuring positioning data collection locations L11 to L77 in the target GNSS shaded area TA2 for positioning.

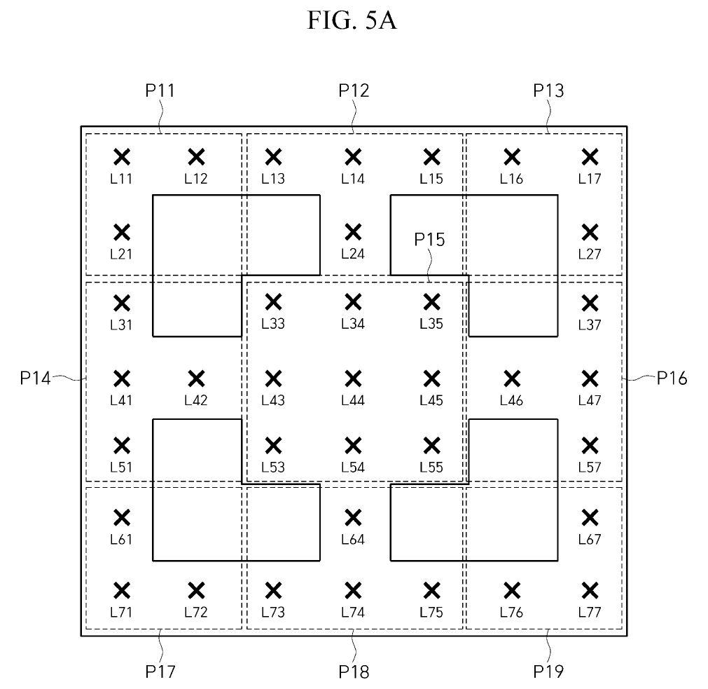

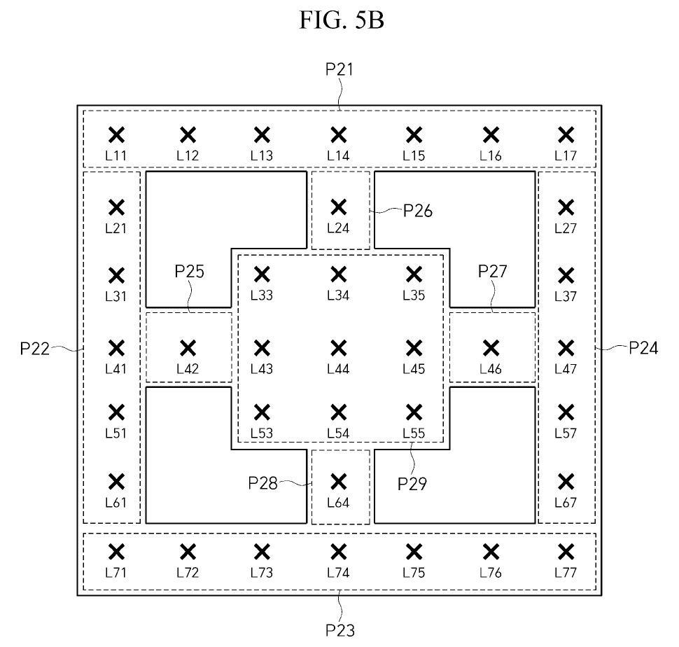

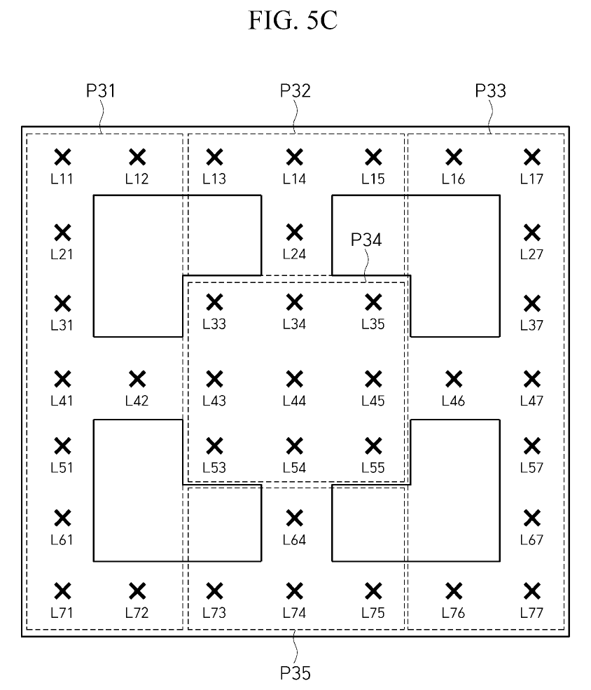

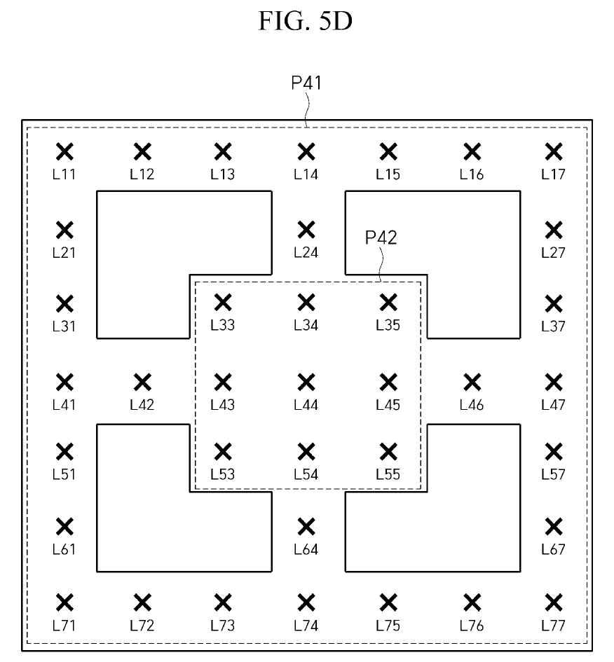

FIGS. 5A to 5D are diagrams illustrating a case of space division in a GNSS shaded area.

FIGS. 5A to 5D illustrate cases in which the GNSS shaded area TA2 of FIG. 4 is divided in a variety of forms. The positioning apparatus 100 according to the present invention divides the target GNSS shaded area by applying a different similarity function to each divided space to determine the location of a target object (e.g., a user terminal).

FIG. 5A is a case where the GNSS shaded area TA2 illustrated in FIG. 4 is divided into spaces P11 to P19. In FIG. 5A, the respective divided spaces correspond to corner spaces P11, P13, P17, and P19, corridor spaces P12, P14, P16, and P18, and a central space P15.

FIG. 5B is a case where the GNSS shaded area TA2 illustrated in FIG. 4 is divided into spaces P21 to P29. The respective divided spaces represent corridor spaces P21 to P24, a central space P29, and spaces connecting the corridor space and the central space (“connection spaces” P25 to P28).

FIG. 5C is a case where the GNSS shaded area TA2 illustrated in FIG. 4 is divided into spaces P31 to P35.

FIG. 5D is a case where the GNSS shaded area TA2 illustrated in FIG. 4 is divided into two spaces P41 and P42.

The positioning apparatus 100 according to the present invention may divide a target GNSS shaded area and apply various types of similarity functions to the divided space of the GNSS shaded area (hereinafter abbreviated as “divided space”) in order to provide accurate and stable positioning results. There are various methods for dividing the space of the target GNSS shaded area.

Four examples of methods of dividing the space of a GNSS shaded area that can be used by the positioning apparatus 100 according to the embodiment of the present disclosure will be illustrated below.

1) (PM1) A method of dividing the space of a target GNSS shaded area by considering structural aspects of the target GNSS shaded area based on a map (or design drawing) of the target GNSS shaded area (hereinafter referred to as a “first division method” or “structure-based division method”)

2) (PM2) A method of performing a simulation or a preliminary test on a positioning DB established in advance for the target GNSS shaded area and dividing the target GNSS shaded area based on the positioning accuracy derived from the result of the simulation or preliminary test (hereinafter referred to as a “second division method” or “positioning accuracy-based division method”)

3) (PM3) A method of dividing the target GNSS shaded area according to the type of positioning resource (infrastructure) that can be used in the target GNSS shaded area (hereinafter referred to as a “third division method” or “positioning resource-based division method”)

4) (PM4) In consideration of the maintenance and management aspects of the positioning DB collected for the target GNSS shaded area, a method of dividing the target GNSS shaded area based on the update cycle of the positioning DB (hereinafter referred to as a “fourth division method” or “positioning DB update cycle-based division method”)

The first division method PM1 is a method of dividing the target GNSS shaded area based on a static spatial configuration of the target GNSS shaded area. For example, the positioning apparatus 100 may divide the target GNSS shaded area in consideration of the purpose (name) and/or geometric structure of the space that has been allocated in advance to each portion of the target GNSS shaded area, such as a conference room, a lounge, a hallway, and a plaza that constitute the target GNSS shaded area.

When the GNSS shaded area is assumed to be an internal space of a specific building, the structure-based division method PM1 has the advantage of allowing the target GNSS shaded area to be divided in advance according to purposes based on information such as a design drawing generated during the construction of the building. However, since the structure-based division method PM1 does not refer to the positioning accuracy provided at each indoor location of the target GNSS shaded area, there is a possibility that it may not secure high positioning accuracy.

For example, FIG. 5B or FIG. 5D may be results of dividing the space of the target GNSS shaded area to which the structure-based division method PM1 is applied.

The second division method PM2 is a division method based on positioning accuracy and evaluates the positioning accuracy achieved at each point in advance using a positioning DB established based on positioning data collected for each point in the target GNSS shaded area and a predefined similarity function F, and divides the space of the target GNSS shaded area according to the positioning accuracy.

For example, based on results of verifying the positioning accuracy by applying the first similarity function F1 to each point within the GNSS shaded area TA2 illustrated in FIG. 4, when positioning accuracy with an error range of 8 m is measured at points L33, L34, L35, L43, L44, L45, L53, L54, and L55, and positioning accuracy with an error range of 3 m is measured at other points, the positioning apparatus 100 may set L33, L34, L35, L43, L44, L45, L53, L54, and L55 as a single divided space and may set a second similarity function F2, which can obtain higher positioning accuracy (e.g., an error of 3 to 4 m), to be applied to these points. FIG. 5D can be the result of dividing the target GNSS shaded area when the target GNSS shaded area is divided in this manner.

When the target GNSS shaded area is divided in this manner and a similarity function F is designated and utilized for each divided space, it is possible to apply a similarity function that produces more accurate results for each location in the target GNSS shaded area.

The third division method PM3 is a positioning resource-based method PM3. When the arrangement of positioning resources (e.g., Wi-Fi access points, BLE beacons, LTE base stations, geomagnetic sensors, etc.) that can be used for positioning in the target GNSS shaded area is divided into detailed spaces and it is efficient to apply different similarity functions according to such arrangement, the third division method PM3 can be said to be a method of dividing a corresponding space based on positioning resource arrangement information (e.g., distribution of positioning resources).

For example, in FIG. 5C, when positioning using Wi-Fi can be provided relatively accurately at points L11, L12, L21, L31, L41, L42, L51, L61, L71, and L72, positioning using geomagnetism can be provided relatively accurately at points L13, L14, L15, and L24, positioning using BLE can be provided relatively accurately at points L64, L73, L74, and L74, positioning using both geomagnetic sensors and BLE can be provided relatively accurately at points L16, L17, L27, L37, L46, L47, L57, L67, L76, and L77, and positioning using all of them can be provided relatively accurately at points L33, L34, L35, L43, L44, L45, L53, L54, and L55, the positioning apparatus 100 may divide the space so that different similarity functions can be used at each location based on this positioning resource suitability information. The result of applying the positioning resource-based division method PM3 can be shown as an example of the space division result in FIG. 5C.

The fourth division method PM4 is a method of dividing the target GNSS shaded area in consideration of the update cycle of the positioning DB according to the characteristics of the target GNSS shaded area when collecting positioning data for each point in advance to establish a positioning DB in order to provide fingerprint-based positioning. When applying the division method PM4 based on the positioning DB update cycle, the positioning apparatus 100 performs a method of updating a similarity function that can maintain the accuracy level for a corresponding portion of the positioning DB according to the partial update of the positioning DB.

For example, in FIG. 5D, when the positioning DB of points L33, L34, L35, L43, L44, L45, L53, L54, and L55 needs to be frequently updated depending on a user movement pattern and a purpose of utilizing the target GNSS shaded area, the positioning apparatus 100 may set the corresponding points as a separate divided space so that the similarity function applied to the separate divided space can be easily updated. As a specific example, in the case of an exhibition hall where structures, exhibition booths, information desks, and convenience facilities are repeatedly installed and dismantled, the arrangement of objects or access points frequently changes. In this case, since the list of access points (or the presence/absence of access points) at which signals are received in the internal space and the signal strength change, the positioning DB for the corresponding space needs to be updated. Therefore, the positioning apparatus 100 can optimize the positioning performance by resetting the divided space for the corresponding space, updating the positioning DB, and updating the similarity function corresponding to the divided space.

In addition to the examples described above, there may be various methods of dividing the space of the GNSS shaded area based on different purposes and perspectives (e.g., from the perspective of ease of service provision), and space division results identical to or different from the cases illustrated in FIGS. 5A to 5D may be obtained.

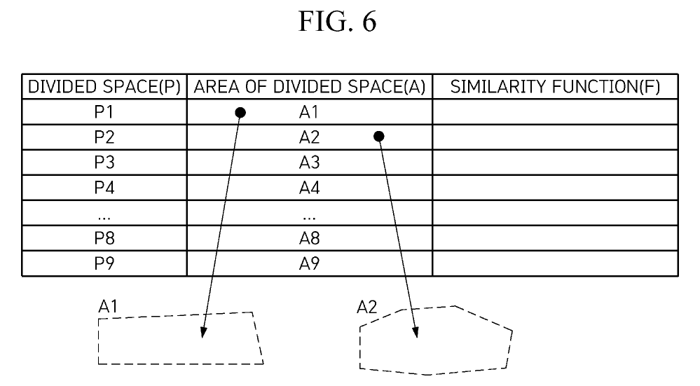

FIG. 6 is an exemplary diagram illustrating a mapping table between a divided space and a similarity function.

For example, when the target GNSS shaded area is divided into spaces P1 to P9, as illustrated in FIG. 6, the positioning apparatus 100 may store and manage results of mapping a divided space P, an area A of the divided space, and a similarity function F applied to the corresponding divided space as a mapping table. Here, the area A of the divided space can be expressed as a polygon as in the example of FIG. 6, as geometric information of the corresponding divided space.

The similarity function applied to each divided space may include the following information.

Function name: Name of similarity function

Parameter: Parameter (argument) determined in advance for executing similarity function

Return value: Type of similarity value obtained as result of executing similarity function

Library: Name of library that needs to be referenced to execute similarity function

Other: Additional information provided for similarity function

As described above, when the similarity function (including information for executing the similarity function) is mapped for each divided space, the positioning apparatus 100 can execute the similarity function mapped to the divided space based on the positioning data included in the positioning DB corresponding to the divided space and the positioning data collected in real time to obtain a similarity value, and determine the location of the target object based on the similarity value.

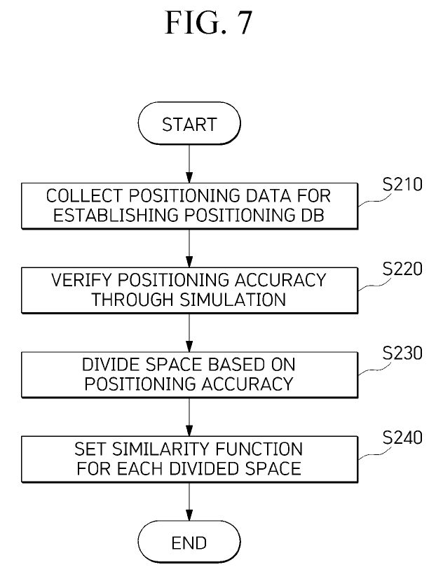

FIG. 7 is a flowchart illustrating a method of dividing a space and configuring a similarity function according to an embodiment of the present invention.

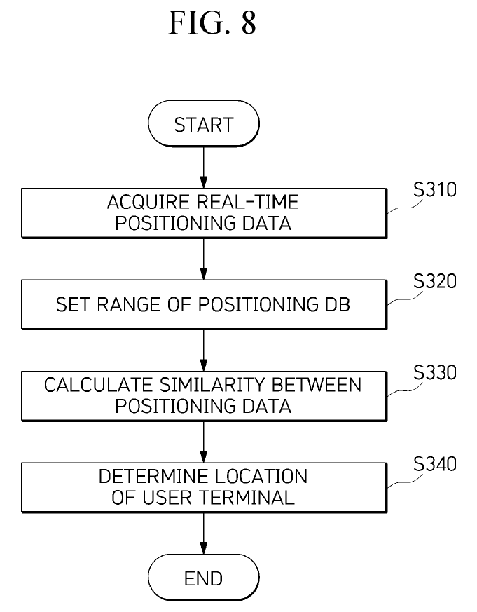

In order to apply different similarity functions according to the division of the target space, which is described as the main content of the present invention in this specification, it is necessary to implement a method of dividing a space and configuring a similarity function as illustrated in FIG. 7. The method of dividing the space and configuring the similarity function of FIG. 7 and the location method of FIG. 8 can be combined with each other. In this case, it is preferable that the space division and similarity function setting method of FIG. 7 precede the positioning method of FIG. 8.

Referring to FIG. 7, the method of dividing the space and configuring the similarity function according to the embodiment of the present invention includes operations S210 to S240.

The method of dividing the space and configuring the similarity function illustrated in FIG. 7 is merely one embodiment, and the operations of the method of dividing the space and configuring the similarity function according to the present invention are not limited to the embodiment illustrated in FIG. 7, and may be added, modified, or deleted as needed.

The embodiment of FIG. 7 is an example in which the positioning accuracy-based division method PM2 among the aforementioned space division methods PM1 to PM4 is applied. That is, in the embodiment of FIG. 7, the positioning apparatus 100 operates in such a manner that it divides the target GNSS shaded area based on the positioning accuracy obtained by performing a simulation or a preliminary test based on the positioning database established in advance in the target GNSS shaded area.

In the embodiment of FIG. 7, the positioning accuracy-based division method PM2 is applied, but the method and sequence of dividing the space of the target GNSS shaded area should be set differently according to the purpose and perspective for dividing the target GNSS shaded area.

In operation S210, positioning data for establishing a positioning DB is collected.

The positioning data collector 40 collects positioning data including a list of access points and the signal strength of each access point at a plurality of locations Li set in a target GNSS shaded area. The positioning data collector 40 transmits the collected positioning data to the positioning apparatus 100, and the positioning apparatus 100 establishes the positioning DB based on the positioning data collected by the positioning data collector 40.

In operation S220, the positioning accuracy is verified through a simulation (or test).

The positioning apparatus 100 obtains the positioning accuracy for each location Li of the target GNSS shaded area using a similarity function F set based on the positioning DB through a simulation or a test.

For example, when obtaining the positioning accuracy through a simulation, the positioning apparatus 100 may generate a probability distribution of the positioning data of each location Li based on the positioning DB, extract simulated positioning data from the probability distribution, calculate a similarity between the simulated positioning data and the positioning data stored in the positioning DB using a similarity function F, estimate the location of a target object virtually positioned at each location Li based on a maximum value of the similarity, and obtain the positioning accuracy based on the estimated location.

In operation S230, the space of the target GNSS shaded area is divided based on the positioning accuracy.

The positioning apparatus 100 may divide the space of the target GNSS shaded area by applying the positioning accuracy-based division method PM2. That is, the positioning apparatus 100 may divide the target GNSS shaded area into a plurality of spaces based on the positioning accuracy. In other words, the positioning apparatus 100 may generate divided space information on the target GNSS shaded area based on the positioning accuracy.

For example, the positioning apparatus 100 may divide the space of the target GNSS shaded area by grouping the locations Li at which the positioning accuracy is obtained to be lower than a predetermined threshold value (see FIGS. 5A to 5D). As another example, the positioning apparatus 100 may divide the space of the target GNSS shaded area by grouping the locations Li that meet a predetermined positioning accuracy range. In this specification, the divided space of the target GNSS shaded area is referred to as a “divided space.”

In operation S240, a similarity function for each divided space is set.

The positioning apparatus 100 searches for and sets a similarity function that can increase the positioning accuracy for the divided space at which the positioning accuracy is lower than the predetermined threshold value or the divided space corresponding to the predetermined positioning accuracy range.

For example, the positioning apparatus 100 searches for a similarity function that exhibits the highest positioning accuracy by repeatedly obtaining the positioning accuracy of the location Li included in the corresponding divided space while changing the parameter (argument) value of the previously applied similarity function. That is, the positioning apparatus 100 searches for a combination of parameter values of the similarity function that can maximize the positioning accuracy for each divided space and sets the similarity function by applying the combination of optimal parameter values to the similarity function for each divided space.

As another example, the positioning apparatus 100 may determine the similarity function for each divided space by changing the type of the similarity function. Examples of the types of similarity functions may include Euclidean distance, Manhattan distance, cosine similarity, and dynamic time warping (DTW). The positioning apparatus 100 may execute both changing the type of similarity function and optimizing the parameters in order to determine an optimal similarity function corresponding to each divided space.

The positioning apparatus 100 sets an area A of the divided space based on the location Li of the target GNSS shaded area allocated to each divided space. The area A of the divided space may be set as a coordinate range of each location Li or may be set as geometric information (e.g., a polygon) of the area. The positioning apparatus 100 generates a mapping table indicating a correspondence relationship between the divided space P, the area A of the corresponding divided space, and the optimal similarity function F applied to the corresponding divided space.

FIG. 8 is a flowchart illustrating a positioning method according to an embodiment of the present invention.

Specifically, FIG. 8 is a flowchart illustrating an embodiment of a positioning method performed using the positioning DB and the mapping table established through FIG. 7.

Referring to FIG. 8, the positioning method according to the embodiment of the present invention includes operations S310 to S340. The positioning method illustrated in FIG. 8 is merely an embodiment, the operations of the positioning method according to the present invention are not limited to the embodiment shown in FIG. 8, and some components may be added, modified, or deleted as needed.

For convenience, the embodiment of FIG. 8 is described under the assumption that it is performed by the user terminal 50 and the positioning apparatus 100.

In operation S310, real-time positioning data is acquired.

The user terminal 50 that has entered the target GNSS shaded area acquires real-time positioning data from the surrounding positioning resources (e.g., access points, beacons, base stations, or geomagnetic sensors) to determine its own location. Hereinafter, for convenience of description, it is assumed that the positioning resources are access points.

For example, the user terminal 50 receives a wireless signal transmitted by a nearby Wi-Fi access point and generates real-time positioning data including a list of receivable access points and the signal strength of each access point based on the received wireless signal.

The user terminal 50 transmits the acquired real-time positioning data to the positioning apparatus 100.

In operation S320, a range of the positioning DB is set.

The positioning apparatus 100 sets the range of the positioning DB that can be compared with the real-time positioning data. Here, the range of the positioning DB is set of the locations Li for which similarity should be compared based on the real-time positioning data received from the user terminal 50. For example, in the case of performing positioning using Wi-Fi, the data (real-time positioning data) collected in real time by the user terminal 50 corresponds to a list of access points APs that can be confirmed at a place where the user terminal 50 is currently located, and the signal strength (RSSI) values transmitted from each access point AP. In this case, the range of the positioning DB for which the positioning apparatus 100 searches for the similarity corresponds to the location Li that includes all the lists of access points collected in real time by the user terminal 50. This is because only such a location can be regarded as a candidate area where the user terminal 50 can exist.

In operation S330, a similarity between the positioning data is calculated.

The positioning apparatus 100 determines the divided space including each location Li of the target GNSS shaded area based on the previously generated mapping table and calculates a similarity value Si between the positioning data for each location Li stored in the positioning DB and the real-time positioning data collected by the user terminal 50 using the similarity function corresponding to each divided space.

In operation S340, the location of the user terminal is determined.

The positioning apparatus 100 determines a location Lx corresponding to a maximum similarity value Sx among the calculated similarity values Si as the location of the user terminal 50. Next, the positioning apparatus 100 transmits the determined location Lx of the user terminal 50 to the user terminal 50.

The method of dividing the space and configuring the similarity function and the positioning method according to an embodiment of the present invention have been described with reference to the flowcharts shown in FIGS. 7 and 8, respectively.

For the sake of simplicity, the method of dividing the space and configuring the similarity function and the positioning method have been illustrated and described as a series of blocks, but are not limited to the order of the blocks, and some blocks may occur in a different order from that shown or simultaneous with other blocks illustrated and described in this specification. Various other branches, flow paths, and orders of blocks that achieve the same or similar results may also be implemented. In addition, not all of the illustrated blocks are necessarily required to implement the method described herein.

Meanwhile, in the description with reference to FIGS. 7 to 8, each step may, according to an embodiment of the present invention, be further divided into additional steps or combined into fewer steps. Further, some steps may be omitted as necessary, and the order of the steps may be changed. In addition, although not explicitly described, the content of FIGS. 1 to 6 may be applied to the content of FIGS. 7 to 8. Also, the content of FIGS. 7 to 8 may be applied to the content of FIGS. 1 to 6.

According to an embodiment of the present invention, it is possible to provide accurate and stable positioning results by applying a different similarity function to each divided space of a GNSS shaded area in fingerprint-based positioning.

Although the above description has referred to exemplary embodiments of the present invention, it will be understood by those skilled in the art that the present invention may be variously modified and changed within the scope of the spirit and scope of the present invention as described in the following patent claims.

What is claimed is:

1. A positioning method comprising:
collecting, by a positioning data collector, first positioning data and transmitting the collected first positioning data to a positioning apparatus in order to establish a positioning DB, wherein the first positioning data includes a list of positioning resources, which transmit wireless signals to the positioning data collector from among a plurality of positioning resources arranged in a target global navigation satellite system (GNSS) shaded area at a plurality of locations set in the target GNSS shaded area, and signal strengths of wireless signals transmitted by each positioning resource included in the list of positioning resources, and transmitting the collected first positioning data to a positioning apparatus;
storing, by the positioning apparatus, the first positioning data in a storage unit to establish the positioning DB;
generating, by the positioning apparatus, simulated positioning data by performing a simulation based on the positioning DB, obtaining a similarity between the simulated positioning data and the first positioning data extracted from the positioning DB by applying a preset similarity function, and obtaining a positioning accuracy for each of the plurality of locations based on the similarity between the simulated positioning data and the first positioning data extracted from the positioning DB;
dividing, by the positioning apparatus, a space of the target GNSS shaded area into a plurality of spaces based on the positioning accuracy, and generating divided space information of the target GNSS shaded area based on a result of the dividing;
optimizing, by the positioning apparatus, parameters of the similarity function so that the positioning accuracy obtained based on the positioning DB is maximized for the divided space having the positioning accuracy lower than a predetermined threshold value among the divided spaces included in the target GNSS shaded area, and resetting the similarity function of the positioning accuracy lower than the threshold value;
generating, by the positioning apparatus, a mapping table representing a relationship between the divided space information of the target GNSS shaded area and the similarity function applied to each divided space based on a result of the resetting of the similarity function;
collecting in real time, by a user terminal that has entered the target GNSS shaded area to determine its own location, the list of positioning resources transmitting wireless signals around the user terminal and a signal strength of the wireless signal transmitted from each positioning resource to the user terminal to generate second positioning data, and transmitting the second positioning data to the positioning apparatus;
determining, by the positioning apparatus, the divided space including each location of the target GNSS shaded area based on the mapping table, extracting a similarity function corresponding to each divided space of the target GNSS shaded area from the mapping table, and calculating a similarity value between the first positioning data stored in the positioning DB and the second positioning data with respect to each location using the extracted similarity function; and
determining, by the positioning apparatus, among each of the locations, a location corresponding to a maximum value among the calculated similarity values as a location of the user terminal.

2. The positioning method of claim 1, further comprising transmitting, by the positioning apparatus, the location corresponding to the maximum value to the user terminal.

3. The positioning method of claim 1, wherein the plurality of positioning resources include any one or a combination of a Wi-Fi access point, a Bluetooth low energy (BLE) beacon, a Long Term Evolution (LTE) base station, and a geomagnetic sensor.

4. The positioning method of claim 1, wherein the generating of the divided space information includes dividing, by the positioning apparatus, the space of the target GNSS shaded area into a plurality of spaces based on the positioning accuracy and a structure of the target GNSS shaded area.

5. The positioning method of claim 1, wherein the generating of the divided space information includes dividing, by the positioning apparatus, the space of the target GNSS shaded area into a plurality of spaces based on the positioning accuracy and arrangement information of the plurality of positioning resources.

6. The positioning method of claim 1, wherein the set similarity function is a cosine similarity function.

7. A positioning apparatus comprising:
a communication unit configured to receive, from a positioning data collector, first positioning data including a list of positioning resources, which transmit wireless signals to the positioning data collector from among a plurality of positioning resources disposed in a target global navigation satellite system (GNSS) shaded area, and signal strengths of wireless signals transmitted by each positioning resource included in the list of positioning resources;
a storage unit;
a memory configured to store computer-readable instructions; and
at least one processor implemented to execute the instructions,
wherein the at least one processor executes the instructions to:
store the first positioning data in the storage unit to establish a positioning DB;
generate simulated positioning data by performing a simulation based on the positioning DB, obtain a similarity between the simulated positioning data and the first positioning data extracted from the positioning DB by applying a preset similarity function, and obtain a positioning accuracy for each of the plurality of locations based on the similarity between the simulated positioning data and the first positioning data extracted from the positioning DB;
divide a space of the target GNSS shaded area into a plurality of spaces based on the positioning accuracy, and generate divided space information of the target GNSS shaded area based on a result of the dividing;
optimize parameters of the similarity function so that the positioning accuracy obtained based on the positioning DB is maximized for the divided space having the positioning accuracy lower than a predetermined threshold value among the divided spaces included in the target GNSS shaded area to reset the similarity function of the positioning accuracy lower than the threshold value; and
generate a mapping table representing a relationship between the divided space information of the target GNSS shaded area and the similarity function applied to each divided space based on a result of the resetting of the similarity function; and wherein
the communication unit is configured to:
determine, when receiving second positioning data which is real-time positioning data including the list of positioning resources transmitting wireless signals around the user terminal from a user terminal that has entered the target GNSS shaded area and a signal strength of the wireless signal transmitted from each positioning resource to the user terminal, the divided space including each location of the target GNSS shaded area based on the mapping table, extract a similarity function corresponding to each divided space of the target GNSS shaded area from the mapping table, and calculate a similarity value between the first positioning data stored in the positioning DB and the second positioning data with respect to each location using the extracted similarity function; and
determine, among each of the locations, a location corresponding to a maximum value among the calculated similarity values as a location of the user terminal.

8. The positioning apparatus of claim 7, wherein the at least one processor is configured to transmit the location corresponding to the maximum value to the user terminal through the communication unit.

9. The positioning apparatus of claim 7, wherein the plurality of positioning resources include any one or a combination of a Wi-Fi access point, a Bluetooth low energy (BLE) beacon, a Long Term Evolution (LTE) base station, and a geomagnetic sensor.

10. The positioning apparatus of claim 7, wherein the at least one processor is configured to divide the space of the target GNSS shaded area into a plurality of spaces based on the positioning accuracy and a structure of the target GNSS shaded area.

11. The positioning apparatus of claim 7, wherein the at least one processor is configured to divide the space of the target GNSS shaded area into a plurality of spaces based on the positioning accuracy and arrangement information of the plurality of positioning resources.

12. The positioning apparatus of claim 7, wherein the set similarity function is a cosine similarity function.
